(19) United States
(12) Patent Application Publication
(10) Pub. No.: US 2004/0234134 A1
(43) Pub. Date: Nov. 25, 2004

(54) Image processing apparatus and image processing method

(75) Inventor: Takahiro Fuchigami, Yokosuka-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/834,331

(22) Filed: Apr. 29, 2004

Related U.S. Application Data
(60) Provisional application No. 60/471,334, filed on May 19, 2003.

(51) Int. Cl. G06K 9/48

(52) U.S. Cl. 382/199

(57) ABSTRACT

An image region discrimination section in an image processing apparatus subjects each pixel to a plurality of kinds of intermediate determinations as a pre-stage of a final attribute determination. Where necessary, the determination results are mutually referred to, and intermediate determination results are corrected once or more. The corrected intermediate determination results are synthesized to produce a final determination result.

### BACKGROUND OF THE INVENTION

The present invention relates to an image processing apparatus and an image processing method, which perform a process of discriminating image attributes of each pixel of an input image, and in particular discriminating a character part or a line part on a document image.

There is known a conventional method of using an independent attribute discrimination means and correcting a discrimination result thereof on the basis of a spatial feature, such as connectivity, in the discrimination result itself (Japanese Patent No. 2824991).

In this method, an attribute is once discriminated to produce a binary result, and spatial connectivity, etc., is analyzed, thereby correcting a discrimination result. However, the precision in correction of the determination result in this method is limited. Consequently, there is a problem in that the precision in determination cannot be improved.

### BRIEF SUMMARY OF THE INVENTION

The object of an aspect of the present invention is to provide an image processing apparatus and an image processing method, which can enhance the precision in determining attributes of each pixel of an image.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of an aspect of the invention.

FIG. 1 shows the structure of a digital full-color copying machine having an image processing apparatus according to the present invention;

FIG. 2 is a block diagram showing an example of the structure of an image region discrimination section;

FIG. 3 is a flow chart illustrating the processing in an edge feature amount calculation section and an edge discrimination section;

FIG. 4 shows examples of coefficients of an edge detection filter;

FIG. 5 shows an example of processing in an edge discrimination correction section and a high-density determination correction section;

FIG. 6 shows an example of processing in the high-density determination correction section; and

FIG. 7 is a flow chart illustrating the processing in a determination result synthesis section.

### DETAILED DESCRIPTION OF THE INVENTION

An embodiment of the present invention will now be described with reference to the accompanying drawings.

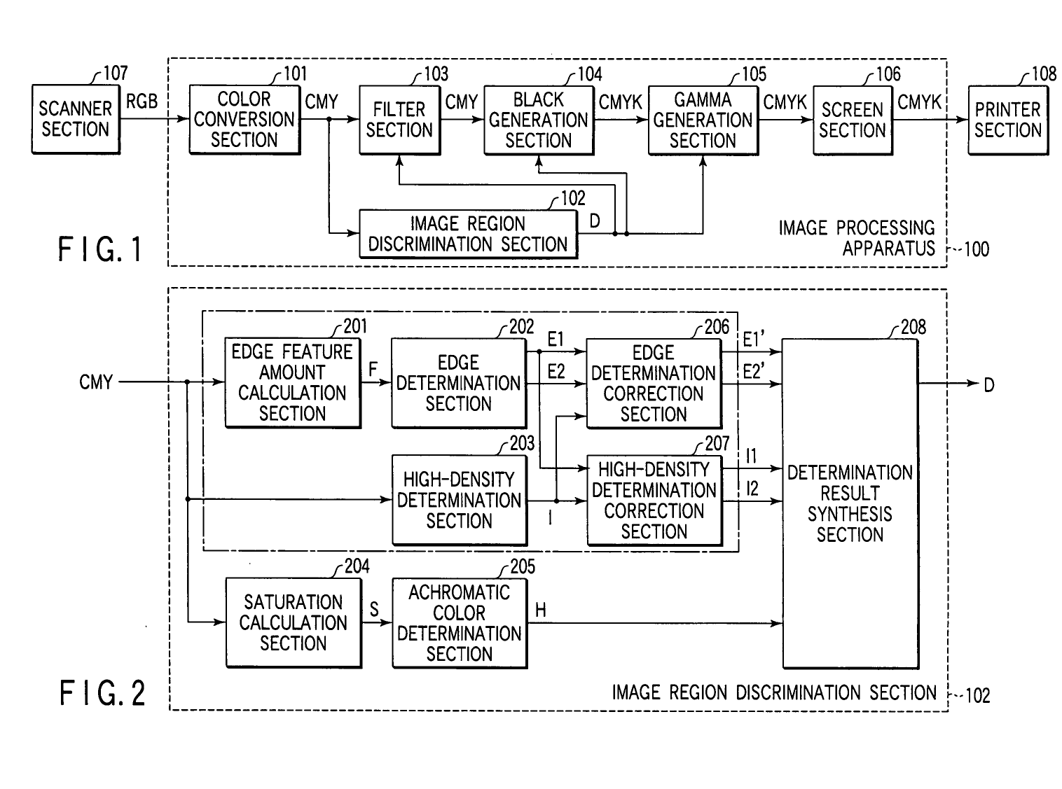

FIG. 1 shows the structure of a digital full-color copying machine having an image processing apparatus according to the present invention. The digital full-color copying machine comprises a scanner section 107, an image processing apparatus 100, and a printer section 108.

For simple description, signal lines for three colors (R, G, B) or four colors (C, M, Y, (K)), which connect process blocks, are depicted by a single line (the same applies to the whole specification).

The scanner section 107 optically reads an original placed on an original table (not shown) by means of line sensors of three colors, R (red), G (green) and B (blue). The scanner section 107 subjects the read image signals to A/D conversion and range correction, and produces R, G and B image signals.

The image processing apparatus 100 includes a color conversion section 101, an image region discrimination section 102, a filter section 103, a black generation section 104, a gamma correction section 105 and a screen section 106. The image processing apparatus 100 discriminates a character/line part in an image represented by image signals input from the scanner section 107, emphasizes the discriminated character/line part, and outputs it to the printer section 108.

The color conversion section 101 converts, in units of pixels, R, G and B image signals input from the scanner section 107 to image signals representing the amount (gray level) of C (cyan), M (magenta) and Y (yellow) corresponding to ink colors used in image formation by the printer section 108.

The image region discrimination section 102 discriminates whether each pixel of the input original image is associated with a character part or a line part. The details are described later.

The filter section 103 receives the C, M and Y image signals, and finds a weighted linear sum of pixel values within a reference image region, which centers on a pixel of interest of each color. Thereby, a gain control in a specific frequency band is effected. This aims at enhancing the sharpness of an image. Unlike a character/line image part, a halftone-dot photo part leads to a moiré if the frequency of halftone dots thereof is emphasized. It is thus necessary to change filter characteristics in accordance with the result of the aforementioned image-region discrimination.

The black generation section 104 generates an image signal of a black (K) component to be added to the C, M and Y image signals output from the filter section 103, thereby enhancing reproducibility of a black character, a shadow part, etc. in the printer section 108. In well-known processing in the black generating section 104, a value of K is calculated by multiplying minimum values of the three colors (CMY) by a predetermined value Z (0≦=Z≦=1), and new CMY values are obtained by subtracting the K value from the CMY values. The equations used in this processing are given by

K=Z·min (C, M, Y)

C′=C−K

M′=M−K

Y′=Y−K.

In addition, as regards black character/black line parts, a mean value of the three CMY colors is taken as a K value, and the value of each of C, M and Y is set at zero, as expressed by the following equations:

K=(C+M+Y)/3

C′=M′=Y′=0.

The gamma correction section 105 converts image signal values of the respective colors to actual ink amounts using conversion tables, thereby matching tone characteristics of image signals with those of an image formed based on ink amounts in the printer section 108. A conversion table for emphasizing contrast is used to enhance the sharpness of the character/line image part.

The screen section 106 performs dithering for effecting pseudo tone reproduction (area modulation) using a predetermined number of pixels, in a case where the number of gray levels in the image formation in the printer section 108 is less than that of image signals. For example, when a 256-gray-level image signal is to be output by a 2-gray-level printer, 256 gray levels (actually 257 gray levels) can theoretically be reproduced if 16×16 pixels are used. It should be noted, however, that if a character/line image part is simply subjected to area modulation, an edge structure may possibly be degraded. In order to keep the edge structure, a pixel determined to be a character/line is simply binarized, and the other pixels alone are used to perform tone reproduction.

The printer section 108 performs image formation by transferring, onto paper, inks in the amounts determined based on CMYK image signals output from the image processing apparatus 100.

FIG. 2 shows an example of the structure of the image region discrimination section 102 according to the present invention. The image region discrimination section 102 comprises an edge feature amount calculation section 201, an edge determination section 202, a high-density determination section 203, a saturation calculation section 204, an achromatic color determination section 205, an edge determination correction section 206, a high-density determination correction section 207, and a determination result synthesis section 208. Although not shown, line memories for buffering signals need to be provided before or after these processing sections.

The edge feature amount calculation section 201 calculates an edge feature amount of each pixel of interest by examining the density gradient within a reference image region centering on the pixel of interest in a plurality of directions.

The edge determination section 202 compares the edge feature amount obtained by the edge feature amount calculation section 201 with a predetermined threshold, and determines whether the pixel of interest corresponds to an edge part.

The high-density determination section 203 compares a “K value” generated based on each of CMY colors and a linear sum thereof with a predetermined threshold. If the “K value” is the threshold or more, it is determined that the associated color image is possibly a character, and the determination result is substituted in “I” and output.

The saturation calculation section 204 calculates a chroma saturation representing the degree of coloring of each pixel of interest as a numerical value. For example, the saturation is calculated by the following equations:

V=(C+M+Y)/3

S=(C−V)²+(M−V)².

The achromatic color determination section 205 compares the saturation calculated by the saturation calculation section 204 with a predetermined threshold, and determines whether each pixel is achromatic or chromatic. The determination result is substituted in “H” and output.

The edge determination correction section 206 corrects the edge determination result by analyzing spatial connectivity in the image region including the pixel of interest, on the basis of the determination results output from the edge determination section 202 and high-density determination section 203.

The high-density determination correction section 207 corrects the density determination result by analyzing spatial connectivity in the image region including the pixel of interest, on the basis of the determination results output from the edge determination section 202 and high-density determination section 203.

The determination result synthesis section 208 logically synthesizes the determination results output form the edge determination correction section 206, high-density determination correction section 207 and achromatic color determination section 205.

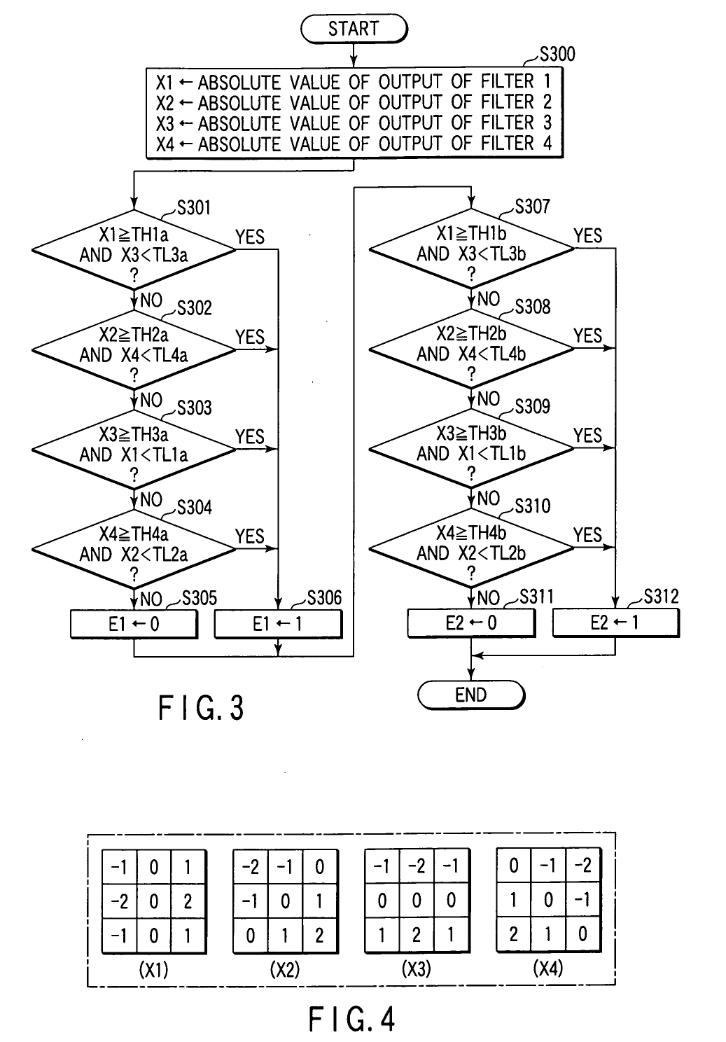

FIG. 3 is a flow chart illustrating the processing in the edge feature amount calculation section 201 and edge determination section 202.

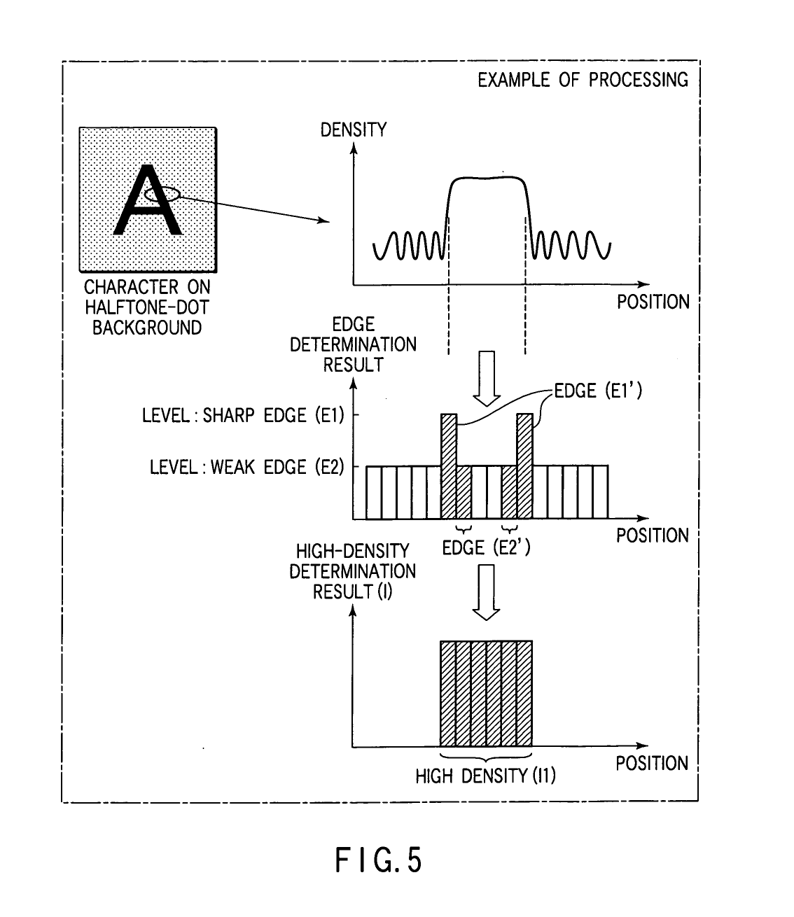

The edge feature amount calculation section 201 calculates edge feature amounts X1 to X4 using four edge detection filters as shown in FIG. 4 (step S300). The edge feature amounts X1 to X4 represent an edge component in a horizontal direction, an edge component in an upper-left-to-bottom-right oblique direction, an edge component in a vertical direction and an edge component in a bottom-left-to-upper-right oblique direction, respectively.

Subsequently, the edge determination section 202 compares the edge feature amounts X1 to X4 with predetermined thresholds (TH1a to TH4a, TL1a to TL4a) and determines whether the pixel of interest is an edge part or not (“first determination”). The determination result is substituted in “E1”.

Specifically, if X1≧TH1a and X3<TL3a (S301), “1” is substituted in “E1” (S306).

If the condition, X1≧TH1a and X3<TL3a, is not met and X2≧=TH2a and X4<TL4a (S302), “1” is substituted in “E1” (S306).

If the condition, X2≧TH2a and X4<TL4a, is not met and X3≧TH3a and X1<TL1a (S303), “1” is substituted in “E1” (S306).

If the condition, X3≧TH3a and X1<TL1a, is not met and X4≧TH4a and X2<TL2a (S304), “1” is substituted in “E1” (S306).

If the condition, X4≧TH4a and X2<TL2a, is not met, “0” is substituted in “E1” (S305).

In each determination step, if the edge feature amount in a certain direction has a predetermined value or more and the edge feature amount in a direction intersecting at right angles with this certain direction is less than a predetermined amount, an edge in this certain direction is determined.

Further, the edge determination section 202 compares the edge feature amounts X1 to X4 with predetermined thresholds (TH1b to TH4b, TL1b to TL4b) and determines whether the pixel of interest is an edge part or not (“second determination”). The determination result is substituted in “E2”.

Specifically, if X1≧TH1b and X3<TL3b (S307), “1” is substituted in “E2” (S312).

If the condition, X1≧TH1b and X3<TL3b, is not met and X2≧TH2b and X4<TL4b (S308), “1” is substituted in “E2” (S312).

If the condition, X2≧TH2b and X4<TL4b, is not met and X3≧TH3b and X1<TL1b (S309), “1” is substituted in “E2” (S312).

If the condition, X3≧TH3b and X1<TL1b, is not met and X4≧=TH4b and X2<TL2b (S310), “1” is substituted in “E2” (S312).

If the condition, X4≧TH4b and X2<TL2b, is not met, “0” is substituted in “E2” (S311).

The process of steps S301 to S312 is executed for each of C, M and Y colors. A similar process is executed for “K” by averaging the edge feature amounts of C, M and Y. It should be noted, however, that the threshold for determining E1 is set to be higher than the threshold for determining E2 in any of the directions and for any of the colors. In other words, the pixel with E1=1 is a “sharp edge”, and the pixel with E1=0 and E2=1 is a “weak edge”.

FIG. 5 shows an example of the processing in the edge determination correction section 206 and high-density determination correction section 207.

A contour (edge) of a character tends to be determined to be a sharp edge (E1) since it has a large edge feature amount, and a part near the contour of the character tends to be determined to be a weak edge (E2). On the other hand, a part on a halftone-dot background region may possibly be determined to be a weak edge due to non-uniform density, etc.

In the present invention, edge intensity levels are individually determined. An edge with high intensity is corrected to be an edge (E1′). As regards edge parts with low intensity, only an edge connected to a high-intensity edge is corrected to be an edge (E2′). Moreover, as regards parts determined to be high-density parts (I) by the high-density determination section 203, only a part connected to a high-intensity edge (E1) is corrected to be a high-density part (I1). Thereby, it becomes possible to reduce the possibility that a halftone dot on a halftone region is erroneously determined to be an edge or a high-density part.

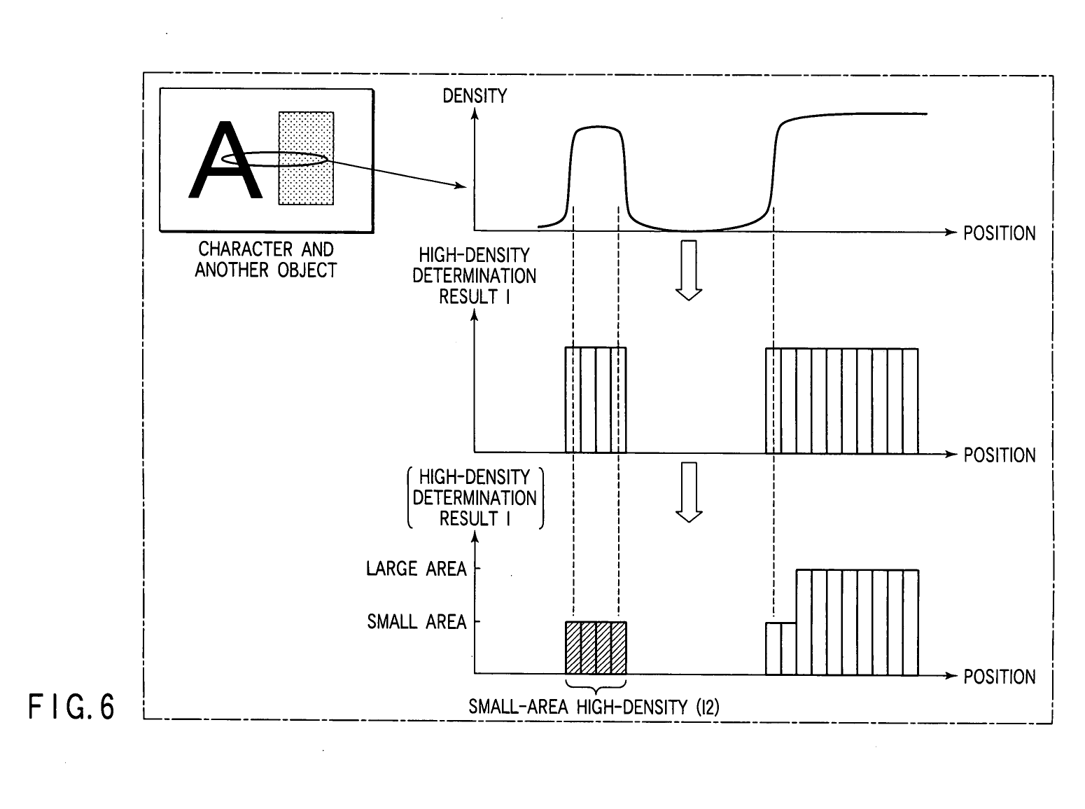

FIG. 6 shows an example of the processing in the high-density determination correction section 207.

A character and another object, which are formed of high-density pixels, are determined to be high-density parts (I) in the high-density determination section 203. In this case, the pixels determined to be high-density parts are classified into a small spatial distribution area (small area) and a large spatial distribution area (large area). Thereby, a fine line, a halftone dot or an object contour is classified into a small area. Only when a high-density part with a small area is not connected to a high-density part with a large area, is the former corrected to be a small-area high-density part (I2).

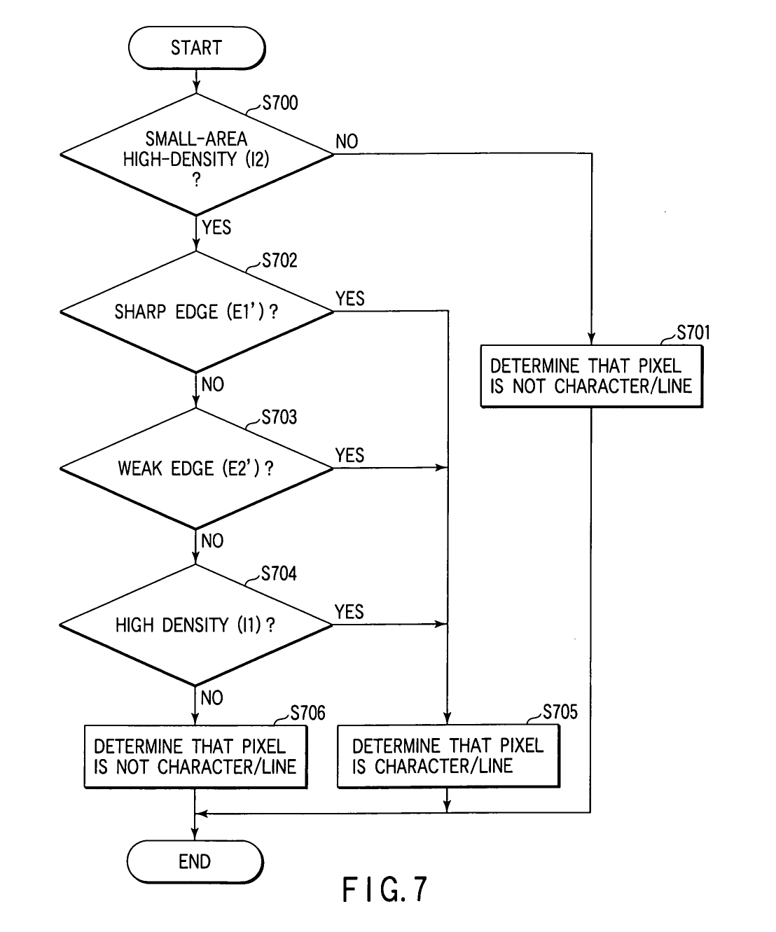

FIG. 7 is a flow chart illustrating the processing in the determination result synthesis section 208. This process is performed by switching the colors of C, M, Y and K in accordance with the determination result of the achromatic color determination section 205. For the purpose of simplicity, the process for one color alone is described.

The determination result synthesis section 208 determines whether the pixel of interest has been corrected to be the small-area high-density part (I2) in the high-density determination correction section 207 (S700). If the determination result is “NO”, it is determined that the pixel is not a character/line part (S701).

On the other hand, if the determination result in step S700 is “YES”, the determination result synthesis section 208 determines whether the pixel has been corrected to be a sharp edge (E1′) in the edge determination correction section 206 (S702). If the determination result is “YES”, it is determined that the pixel is a character/line part (S705).

If “NO” in step S702, the determination result synthesis section 208 determines whether the pixel has been corrected to be a weak edge (E2′) in the edge determination correction section 206 (S703). If the determination result is “YES”, it is determined that the pixel is a character/line part (S705).

If “NO” in step S703, the determination result synthesis section 208 determines whether the pixel has been corrected to be a high-density part (I1) in the high-density determination correction section 207 (S704). If the determination result is “YES”, it is determined that the pixel is a character/line part (S705).

If “NO” in step S704, the determination result synthesis section 208 determines that the pixel is not a character/line part (S706).

As has been described above, according to the embodiment of the present invention, how different determination results are spatially connected is analyzed, and a plurality of determination results are complementarily corrected. Thereby, the precision in determination can be enhanced.

The above-described structures may provide the following image processing apparatuses.

The present invention may provide an image processing apparatus that determines attributes of each of pixels of an input image or each of divided regions, which are composed of a plurality of pixels of an input image, the apparatus comprising: determination means for outputting a plurality of attribute determination results by comparing a plurality of feature amounts, which represent mutually different attributes, with a predetermined threshold with respect to each pixel or each divided region; correction means for analyzing mutual spatial connectivity of said plurality of attribute determination results, and correcting at least one of said plurality of attribute determination results; and synthesizing means for synthesizing said plurality of attribute determination results including the corrected attribute determination result into a single determination result.

The invention may provide an image processing apparatus that determines an attribute as to whether each of pixels of an input image is a character/line part, the apparatus comprising: edge determination means for determining whether each pixel is an edge part by comparing an edge feature amount, which represents a density gradient level, with a predetermined threshold; a high-density determination means for determining whether each pixel is a high-density object by comparing an image density with a predetermined threshold; correction means for analyzing mutual spatial connectivity between the edge determination result and the high-density determination result, and canceling a high-density determination result that is associated with a region, which is not connected to a pixel that is determined to be an edge part; and synthesizing means for synthesizing the edge determination result and the corrected high-density determination result into a character/line part determination result.

The present invention may provide an image processing apparatus that determines attributes of each of pixels of an input image or each of divided regions, which are composed of a plurality of pixels of an input image, the apparatus comprising: attribute determination means for outputting a plurality of attribute determination results by comparing a feature amount, which represents a certain feature, with a plurality of predetermined thresholds with respect to each pixel or each divided region; correction means for analyzing mutual spatial connectivity of said plurality of levels of attribute determination results, and correcting at least one of the attribute determination results; and synthesizing means for synthesizing said plurality of attribute determination results including the corrected attribute determination result into a single determination result.

The invention may provide an image processing apparatus that determines an attribute as to whether each of pixels of an input image is a character/line part, the apparatus comprising: edge determination means for determining, in a plurality of levels, whether each pixel is an edge part by comparing an edge feature amount, which represents a density gradient level, with a plurality of predetermined thresholds; correction means for analyzing mutual spatial connectivity between said plurality of levels of the edge determination result, and canceling an edge determination result with a low level, which is associated with a region that is not connected to a pixel that is determined to be an edge part with a high level; and synthesizing means for synthesizing the edge determination results with the plurality of levels including the corrected determination result into a character/line part determination result.

The present invention may provide an image processing apparatus that determines attributes of each of pixels of an input image or each of divided regions, which are composed of a plurality of pixels of an input image, the apparatus comprising: first determination means for outputting a single or a plurality of attribute determination results with respect to each pixel or each divided region; correction means for analyzing mutual spatial connectivity of said plurality of attribute determination results, and changing, by correction, at least one of the attribute determination results to a plurality of finer attributes; and synthesizing means for synthesizing the attribute determination results of the first determination means and second determination means into a single determination result.

The invention may provide an image processing apparatus that determines an attribute as to whether each of pixels of an input image is a character/line part, the apparatus comprising: area determination means for determining, in a plurality of levels, an area of an object by comparing the number of high-density pixels in a peripheral region of each pixel with a plurality of predetermined thresholds; correction means for analyzing mutual spatial connectivity between said plurality of levels of the area determination means, and changing, by correction, a pixel, which is determined to be a small-area pixel, to a finer attribute on the basis of connectivity to a pixel that is determined to be a large-area pixel and connectivity to a pixel that is determined to a small-area pixel; and synthesizing means for synthesizing the attribute by the area determination means and the attribute by the correction means into a character/line part determination result.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a first determination section that determines attributes of an input image signal;
a second determination section, which is different from the first determination section and determines attributes of the input image signal;
a first correction section that corrects a determination result of the first determination section on the basis of the determination result of the first determination section and a determination result of the second determination section;
a second correction section that corrects the determination result of the second determination section on the basis of the determination result of the first determination section and the determination result of the second determination section; and
a determination result synthesis section that synthesizes a corrected determination result obtained by the first correction section and a corrected determination result obtained by the second correction section, thereby producing a final determination result.

2. The image processing apparatus according to claim 1, wherein the first determination section includes an edge feature amount calculation section that calculates, as an edge feature amount, a density gradient within a predetermined image region centering on a pixel of interest in the input image signal in a plurality of directions, and an edge determination section that compares a plurality of edge feature amounts calculated by the edge feature amount calculation section with a predetermined threshold and determines whether the pixel of interest corresponds to an edge part.

3. The image processing apparatus according to claim 1, wherein the second determination section compares a pixel of interest in the input image signal with a predetermined threshold and determines whether the pixel is a high-density part.

4. The image processing apparatus according to is claim 2, wherein the first correction section corrects an edge determination result by analyzing spatial connectivity in a predetermined image region including the pixel of interest, on the basis of the determination result of the first determination section and the determination result of the second determination section.

5. The image processing apparatus according to claim 3, wherein the second correction section corrects a high-density determination result by analyzing spatial connectivity in a predetermined image region including the pixel of interest, on the basis of the determination result of the first determination section and the determination result of the second determination section.

6. The image processing apparatus according to claim 1, wherein the second correction section compares, based on the determination result of the first determination section and the determination result of the second determination section, the number of high-density pixels in a predetermined image region of the pixel of interest with a plurality of thresholds, thereby determining an area of an object at a plurality of levels, analyzing mutual spatial connectivity between the plurality of levels, and correcting a pixel determined to be a small area on the basis of connectivity to a pixel determined to be a large area.

7. The image processing apparatus according to claim 1, wherein the determination result synthesis section logically synthesizes the corrected determination result obtained by the first correction section and the corrected determination result obtained by the second correction section.

8. The image processing apparatus according to claim 1, wherein the determination result synthesis section includes a saturation calculation section that calculates a chroma saturation representing a degree of coloring of the pixel of interest of each color of the input image signal as a numerical value, and an achromatic color determination section that compares the saturation calculated by the saturation calculation section with a predetermined threshold and determines whether the pixel is achromatic or not, and the determination result synthesis section synthesizes a determination result of the achromatic color determination section, the corrected determination result obtained by the first correction section and the corrected determination result obtained by the second correction section, thereby producing a final determination result.

9. An image processing method comprising:
determining attributes of an input image signal by a first determination section;
determining attributes of the input image signal by a second determination section which is different from the first determination section;
correcting a determination result of the first determination section on the basis of the determination result of the first determination section and a determination result of the second determination section;
correcting the determination result of the second determination section on the basis of the determination result of the first determination section and the determination result of the second determination section; and
synthesizing a corrected determination result obtained by the first correction section and a corrected determination result obtained by the second correction section, thereby producing a final determination result.

10. An image processing method comprising:
calculating, as an edge feature amount, a density gradient within a predetermined image region centering on a pixel of interest in an input image signal in a plurality of directions;
comparing a plurality of the edge feature amounts with a predetermined threshold and determining whether the pixel of interest corresponds to an edge part.
comparing the pixel of interest in the input image signal with a predetermined threshold and determining whether the pixel is a high-density part;
correcting the edge determination result by analyzing spatial connectivity in a predetermined image region including the pixel of interest, on the basis of the edge determination result and the high-density determination result;
correcting the high-density determination result by analyzing spatial connectivity in the predetermined image region including the pixel of interest, on the basis of the edge determination result and the high-density determination result; and
synthesizing the corrected edge determination result and the corrected high-density determination result, and producing a final determination result.
